(19) United States
(12) Patent Application Publication
(10) Pub. No.: US 2004/0078805 A1
(43) Pub. Date: Apr. 22, 2004

(54) System method and apparatus for capturing recording transmitting and displaying dynamic sessions

(76) Inventors: Liel Brian, Kfar Saba (IL); Isaac Segal, Cupertino (CA)

Correspondence Address: LOUIS J. HOFFMAN, P.C., 14614 NORTH KIERLAND BOULEVARD, SUITE 300, SCOTTSDALE, AZ, 85254, US

(21) Appl. No.: 10/433,637

(22) PCT Filed: Dec. 3, 2001
(86) PCT No.: PCT/US01/46605

(30) Foreign Application Priority Data
Dec. 1, 2000 (US) 60250692

(51) Int. Cl. H04N 7/16

(52) U.S. Cl. 725/1

(57) ABSTRACT

A system, method and apparatus for automatically providing audio-visual data to convey a dynamic session at a site to remote viewers, which includes capturing from image cameras (22), analyzing, and segmenting the data into distinct components differing from each other by at least one characteristic using the computer (21), selectively encoding and transmitting each of the components through a communication interface (25), and then decoding, reconstructing, and displaying the data to the remote viewers.

### CLAIM OF PRIORITY

This application claims the benefit of U.S. provisional patent application Serial No. 60/250,692 entitled “System, Method and Article of Manufacture for Capturing, Recording, Transmitting and Displaying Multi-Channel, Multi-Layered Audio-Visual Information” filed on Dec. 1, 2000.

### FIELD OF THE INVENTION

The present invention relates generally to the fields of processing, transmitting and displaying images, video editing, video streaming, remote presentations, and distance-learning systems.

### INCORPORATION BY REFERENCE

To the extent not inconsistent with the present application, the following are incorporated by reference as if set forth at length herein: the “Interactive Projected Video Image Display System” disclosed under U.S. Pat. No. 5,528,263 (Platzkcr et al.); the “Method and Apparatus for Processing, Displaying and Communicating Images” disclosed in a non-provisional U.S. patent application filed Oct. 2, 1998 and assigned Ser. No. 09/166,211 pursuant to a provisional application under the title “Remote Virtual Whiteboard,” filed Oct. 3, 1997 and assigned Serial No. 60/060942; the “Method and Apparatus for Visual Pointing and Computer Control” disclosed in a non-provisional U.S. patent application filed Sep. 17, 2001 and assigned Ser. No. 09/936,866 pursuant to aPCT application filed Mar. 17, 2000 and assigned Ser. No. PCT/US00/07118 pursuant to a provisional application filed Mar. 17, 1999; and the “System, Method and Article of Manufacture for Capturing, Recording, Transnitting and Displaying Multi-Channel, Multi-Layered Audio-Visual Information” disclosed in provisional U.S. patent application filed Dec. 1, 2000 and assigned Serial No. 60/250,692.

### BACKGROUND OF THE INVENTION

Schools, universities, training centers, and other organizations utilize instructor-led sessions on a regular basis. It would be advantageous to these organizations and their membership to be able to effectively convey these sessions to remote members simultaneously as they take place (synchronously) or in recorded format (asynchronously). In the context of the Internet computer network there are avariety of eLearning technologies that address this need. Existing solutions vary in complexity, cost and the extent to which they offer the remote participant an effective learning experience. Presently solutions exist that provide the remote participant with an audio-visual presentation that attempts to approximate the physical classroom experience. These solutions present high-quality audio and video so that the participating student can see and hear what the instructor is saying and doing. They typically also provide some means of interaction between student and instructor and/or within a group of student members.

A simple eLearning solution that is easy to implement involves videotaping the lesson using a commonplace video camera (camcorder), which is set-up in a fixed position on a tripod, and transmitting the resulting video to students, e.g. over the internet. However, this solution has several drawbacks, including the following:

Video transmission requires high bandwidth (high speed connections) to convey even a mediocre experience. Teachers often combine verbal explanations/discussion with other means of conveying knowledge—for example: writing on a whiteboard or flipchart, showing objects, displaying slides, executing computer applications and pointing at charts and maps. Showing the fine detail of such activities—in acceptable video quality—requires very high bandwidth, which is not commonly available.

Capturing fine detail also requires high quality camera equipment or, alternatively, the ability to “zoom in” with the camera on the part of the scene containing the relevant information at any given time during the session. This implies using either an expensive video camera or hiring a camera crew that simultaneously captures the scene with different framing parameters.

An attentive, in-class (physical) student will usually view the front of the classroom and the instructor continuously, yet she will often shift the focus of her attention to the current “focal point” of activity—whiteboard, slide, chart etc. Since the remote participant's experience is, by necessity, less “all encompassing” than that of the in-class participant, it is important that the presentation be made as dynamic and engaging as possible to reduce the likelihood that the viewer will be distracted or will lose interest and discontinue viewing. In this regard, recording a static, unchanging view of the classroom typically produces a boring experience that is unlikely to retain the viewer's interest.

The most accessible means by which remote students can view a session is on a computer monitor, which necessarily limits the amount of visual information that can be displayed at one time. The precise limit depends on the displayed resolution (VGA, SVGA, XGA etc.). Even if the entire classroom were video-captured at the highest quality possible, much of the detail may be lost when large portions of the scene must be fit into a small display area on the monitor.

These observations highlight the fact that conveying an engaging and informative audio-visual classroom experience using the prior art necessarily involves a combination of expensive resources—high quality video equipment and/or professional personnel, as well as high speed communications. Given sufficient resources, an organization could achieve an excellent solution by placing several cameramen equipped with high-grade video cameras to record instructor-led sessions. Each camera would cover a different “shot” aimiing at a different focal point in the classroom and faming different sized views (greater or lesser zoom) of the scene. A director and/or editor would select the most appropriate shots either during or after recording and the result would be made available to remote participants. Theses would use high-speed connections (such as DSL or cable-modem or better) and high-resolution displays to view the video while retaining a sufficient level of the captured detail.

Prior art that partially addresses this problem includes the WebLearner product offered by Tegrity Inc. of San Jose, Calif. (www.tegrity.com). WebLearner software is based on the technology disclosed in the patent application titled “Method and Apparatus for Processing, Displaying and Communicating Images.” WebLearner utilizes inexpensive recording equipment to automatically record sessions that are based on slide presentations and that may incorporate other visual aids such as documents and three-dimensional objects that can be placed under a document camera. The instructor can write marlings on a whiteboard (for example, annotate slides projected onto that whiteboard) and can use the InterPointer device bundled with WebLearner to point at information on the board. The InterPointer is a laser-pointing device and software based on the technology disclosed in the patent application titled “Method and Apparatus for Visual Pointing and Computer Control.” In addition, WebLearner incorporates a touch-activated visual control panel that is projected onto the whiteboard. This panel, which is based on the “Interactive Projected Video Image Display System” disclosed under U.S. Pat. No. 5,528,263, allows the instructor to navigate through the slide presentation (advance slides) and control various aspects of the recording.

When viewing a session recorded with WebLeamer the remote viewer hears the instructor and sees a high quality playback of the information from the projected whiteboard area—including the projected slide, marker annotations and a “cursor” that indicates where the instructor pointed (with the InterPointer). A separate display window shows the viewer a small video image of the instructor.

While WebLearner addresses some of the problems in the prior art it has several important shortcomings when compared with the present invention. WebLearner records activity only in restricted regions—a portion of a whiteboard in which slides or computer applications are projected and annotated and documents or objects placed under a camera. Any activity outside these regions is lost to the viewer. In addition, the video image of the instructor conveys little information and, at best, provides a “social aspect”—assuring the viewer that the instructor is a real person. This video is obtained from a camera that the instructor can aim at a limited area and requires that the instructor stay within the confines of this area to remain in view throughout the session. Since this video is displayed to the viewer separately from the whiteboard area it creates two focal points for the viewer, which may be distracting. Due to constraints imposed by viewer connection speeds and display sizes, the video window is small and at low connection speeds shows poor quality images, factors which severely limit the informational content that the video conveys. The resulting viewing experience, although engaging and efficient in recording and transmission resources, is narrow and restrictive and does not approach that of a person present in the recorded session or that of a broadcast-quality video presentation.

### SUMMARY OF THE INVENTION

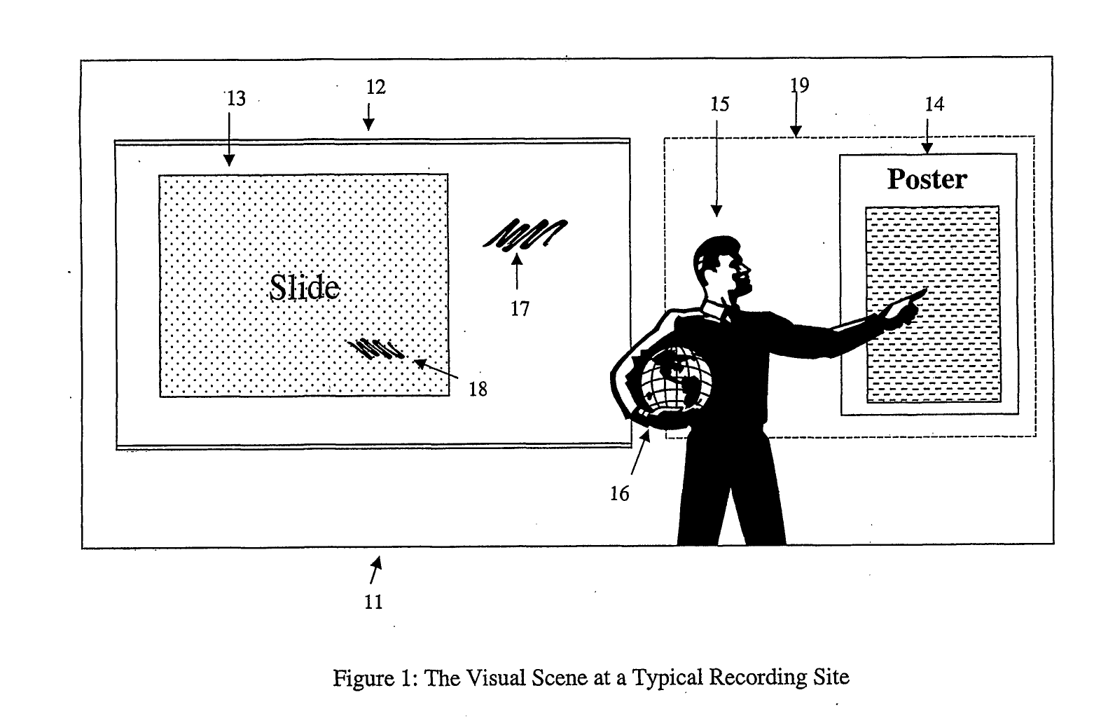

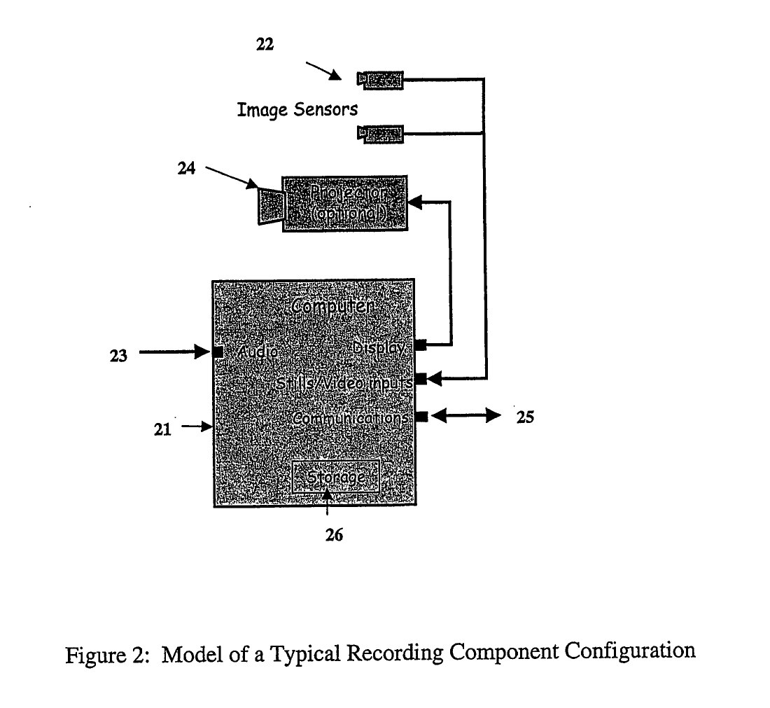

The present invention is a system, method and apparatus for automatic capturing, recording, transmitting and displaying of audio-visual information to convey a human-facilitated session at one site, referred to as the recording site, to remote viewers—in either synchronous or asynchronous modes. The present invention automatically assesses the instructional scene at the recording site, to break it down into meaningful components—which may be of digital nature, such as projected slides, or of the nature of video images—to transmit each component in a manner that best utilizes the available communication medium, and to reconstruct an engaging viewing experience for remote viewers. One aspect of the present invention is to provide the remote viewer with an experience that is similar to that of a viewer present at the recording site and of higher quality than transmitting an ordinary video recording over the same communication medium—for any given communication bandwidth. Another aspect of the present invention is to achieve this while utilizing only inexpensive, commonplace equipment and communication media at both the recording and remote viewing sites. Yet another aspect of the present invention is to operate automatically necessitating little to no human intervention. In the present invention, the recording site is equipped with a computer, including a sound recording device and one or more image sensing devices. Typically the site may be a room, such as a classroom, further equipped with a whiteboard and other visual aids such as flipcharts, posters and arbitrary objects. Often a projector is used to project information from the computer or from transparencies onto a screen or onto the whiteboard. The presentation and recording equipment are positioned facing the front of the room such that all the pertinent visual elements may be contained in the viewable scene. A typical example of such a visual scene is depicted in FIG. 1. An exemplary model configuration of presentation and recording equipment is shown in FIG. 2. During the session the facilitator or instructor [15] moves freely within the visual scene [11], gestures and points at its elements (e.g. at poster [14]), makes markings [17][18] on the whiteboard [12] and/or flipchart, projects multiple slides or images [13] via a projector [24], and manipulates physical objects [16] while verbally presenting subject matter.

The scene may be captured by one or more image sensing devices [22] throughout the session along with the audio of the instructor's speech [23]. The captured information maybe transmitted in real-time to the computer [21] for processing by software. The captured images provide both high definition images, in which fine detail is discernable, and motion video as a rapid succession of images (approaching 30 frames per second), which enables a viewing sensation of smooth motion. Acquiring these two types of images—high quality still images and high frequency motion video may require multiple image sources. For example, a digital stills camera, such as a Kodak DC4800 can periodically (e.g. at 5-10 second intervals) provide high-resolution still images, while a digital camcorder, such as a Sony TRV103 can provide a flow of video images of lesser resolution. These cameras are commonplace and inexpensive. Future technological advances or alternative components known by one of ordinary skill in the art may allow using a single image capture source to provide both sufficient quality and sufficient motion capture ability as required by this invention. Additional sensing devices may be used to acquire images of documents, three-dimensional objects or other visual aids used during the recorded session.

Inside the computer several software modules analyze the captured images in order to extract both visual and control information. Visual information may include the precise location (boundaries) and appearance of the human instructor, of markings and/or erasures made on whiteboards or flipcharts, of physical objects the instructor may be manipulating as well as locations at which the facilitator may be pointing with a finger, pointing stick or other device, such as a laser-pen. Control information includes decisions as to the current focal point of the session (e.g. has the instructor switched to a discussion centered on the poster [14]?), determining if the instructor is pointing at a visual element and interpreting session-navigation commands such as advancing slides, switching the projector source from a computer-generated slide to a document camera and more. The software can make most of these decisions in real-time, however it is advantageous to store interim information in local storage [26] to revise and improve decisions at a later time—during the session or immediately after its completion. Throughout the session processed information may be transmitted to remote viewers through a communications interface [25]. Alternatively (or in addition), the information may be kept in local storage [26] and transmitted for asynchronous viewing after the session is over. If, as mentioned above, the session undergoes improvement after completion, then asynchronous viewing may offer a better quality experience than synchronous viewing. The local storage [26] may also be capable of maintaining large volumes of “raw data” (such as video footage) on media such as disks or digital tapes allowing more intensive post-session automatic processing to further improve the session quality.

Another software component operates in a computer at each remote viewing site in order to display the session to the viewer at that site. The session appears composed much like a video recording, which shows a sequence of shots portraying some or all of the visual information from the recording site while playing the audio of the instructor's speech. The framing of each shot, i.e. what portion of the visual scene will be displayed, is determined by the software at the recording site, although the viewer may be given the ability to override this automatic mechanism and “navigate” to other parts of the scene at will. As an example, referring to FIG. 1, when the instructor is discussing the poster [14] the shot framed for (preferred) viewing may show the area enclosed in the dashed line [19]. When there is no specific focal point in the scene or when otherwise deemed appropriate, a shot of the entire viewable scene [11] may be used. The present invention includes specialized software algorithms for deciding how best to frame the preferred shot at any given time and for transmitting only small amounts of information to remote viewers in order to display it.

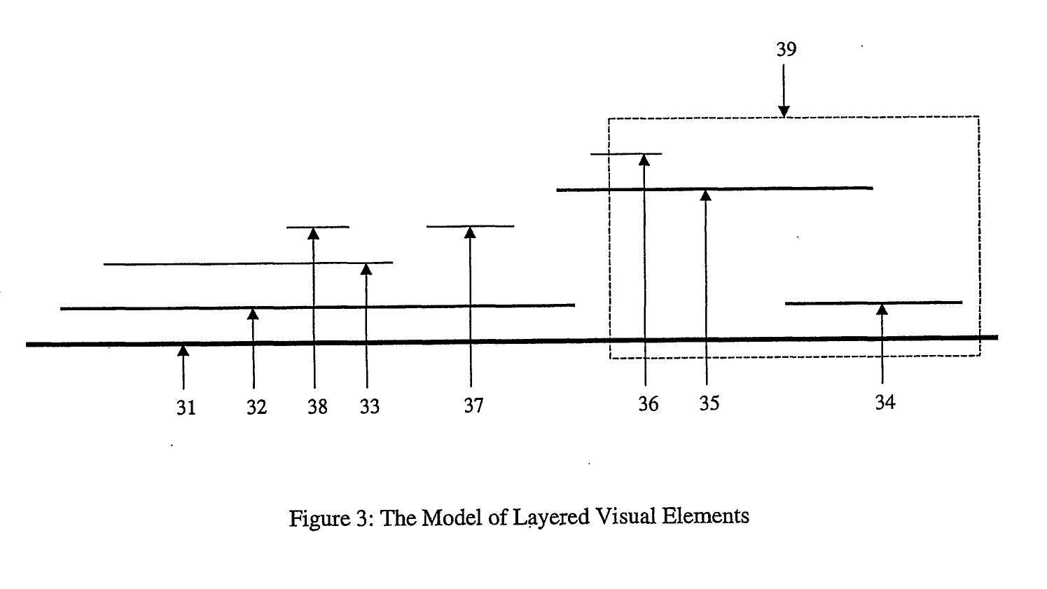

The software modules at recording and viewing sites employ a layered model of the target scene as depicted in FIG. 3. This figure shows a flattened view of the visual elements in FIG. 1 as seen from above. Each labeled item corresponds to the item in FIG. 1 with the same units digit: the entire scene [31] corresponds to [11], the whiteboard [32] to [12], poster [34] to [14], instructor [35] to [15] etc. Elements overlap and are seen layered on top of each other based on their relative distance from the recording equipment. For example, in reality, the whiteboard is hung on the background wall, slides are projected onto the whiteboard, markings are made on the slides and the instructor walks in front of all of these. Hence, in the layered view we see the whiteboard [32] above the background [31], the slides [33] over the whiteboard [32] etc. The segmentation of the scene into distinct visual elements and the layering of these elements are central to the operation of the invention. The visual activity on each individual visual element in the scene is tracked throughout the session recording, and the layering model is used in transmitting and displaying only small amounts of information required for reconstructing the shot displayed to remote viewers. Referring to FIGS. 1 and 3, when the current shot frames the area indicated by [19] the information displayed to the viewers is contained in the layers enclosed by [39]. Consequently, for this shot the system may transmit information only from these regions of the specific layers. Since some layers are relatively static and unchanging (background), we may further reduce transmissions by sending information only about the changes to the specific layers that do undergo changes when those changes occur.

The present invention is not restricted to the specific visual elements described herein nor to any specific combination or layout of elements. The scene may be as simple as a blank wall with a person in front of it or as complex as an arrangement consisting of multiple instances of the elements mentioned above with the addition of other elements not specified here. Other sources of information may also be integrated to enhance the instructional experience. For example, electronic whiteboards or other input devices and information sources may supply additional layers, which can be combined with the existing layers to create an enhanced learning experience within the framework of this invention.

### DETAILED DESCRIPTION OF THE INVENTION

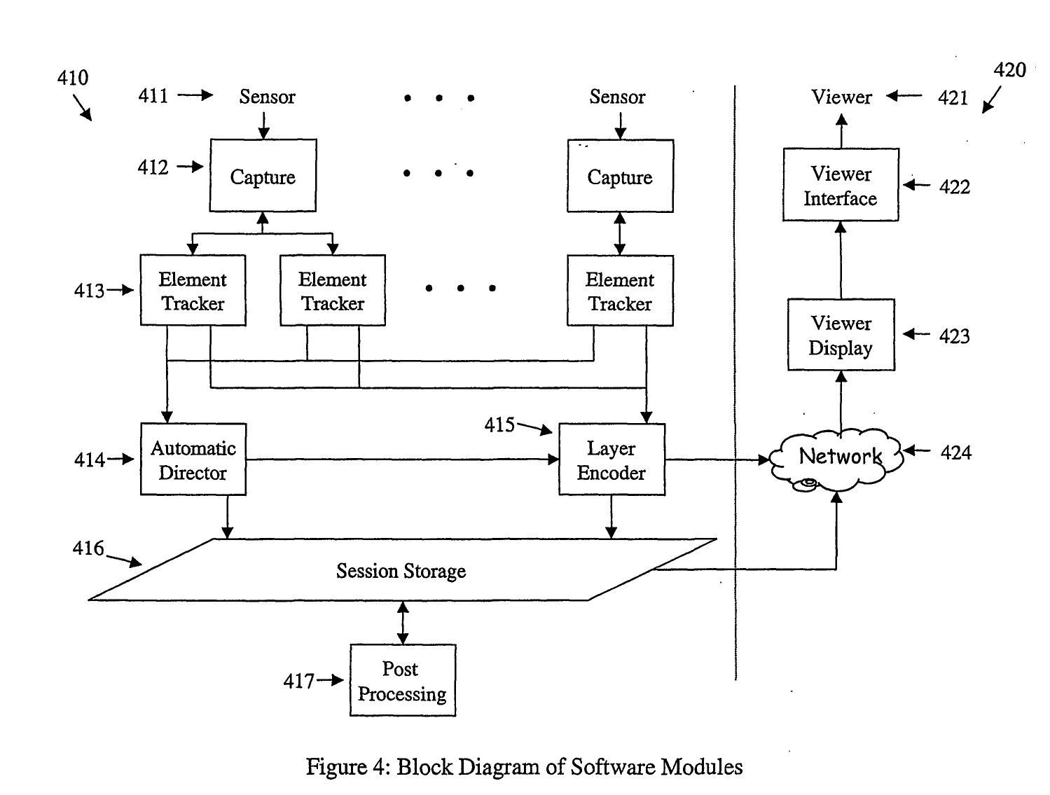

FIG. 4 shows a block diagram of the principal processing components of the invention The recording site [410] acquires visual input from one or more image sensor devices [411 ]. Each sensor has a Capture module (or driver) [412] capable of acquiring images from that sensor. Each sensor and its associated capture module are configured to provide images at predefined resolutions, frame-rates and quality settings to one or more Element Tracker modules [413]. Depending on the capabilities of each sensor, the Element Tracker modules may control the acquisition of frames. For example, a stills camera may be commanded to snap pictures at instances dictated by the Element Trackers that analyze the images that it provides. Each Element Tracker is responsible for tracking the activity of a particular visual element. It provides both the captured image data and information specifying: whether there is activity on the element or not, what the nature of that activity is, and the precise location or boundaries of activity in the image. For example, an Element Tracker that tracks activity on the whiteboard [12] would detect that new markings [17] appear on it and would output this fact and the relevant image data. As another example, an Element Tracker responsible for tracking the instructor [15] would indicate instructor motion in the scene, the precise boundaries of the instructor in the image and information about the instructor's gestures (e.g. pointing).

All tracking information is routed from the Element Trackers [413] to the Automatic Director [414] and Layer Encoder [415] modules. The former combines all information about current activity along with other information about the session and predetermined constraints and produces directives that are passed to the Layer Encoder [415]. These directives indicate the framing parameters of the current preferred shot. These parameters include the bounding rectangle of the visual scene that should be used for the current shot and the “zoom factor,” or equivalently the bounding rectangle in the target display that the current shot should be rendered upon. Another parameter indicates which of the layers should be displayed for this shot (for example, the Automatic Director may decide to hide the instructor). The Automatic Director also saves some information to Session Storage [416] for later use during the session and for post-session improvement performed by the Post-Processing module [417]. The Layer Encoder [415] uses the image data provided by the Element Trackers [413] and the shot-framing directives provided by the Automatic Director [414] to determine the precise image information that must be encoded and transmitted to remote viewers. It analyzes the changes in each visible layer within the framed shot, determines what information should be used from each imaging source, produces the composite result and, as output, encodes the minimum amount of information to represent the changing appearance of the shot. The Layer Encoder may save information to Session Storage [416] for later processing. It will also save all transmitted information to Session Storage for later retrieval by asynchronous remote viewers. The invention may also be used without synchronous transmissions, in which case all output is stored for asynchronous viewing. To encode the information the Layer Encoder may utilize encoding procedures that have become industry standards, such as MPEG-4.

Each viewing site [420] provides the Viewer [421] with a Viewer Interface module [422], which displays information and allows the Viewer a measure of control over the session playback. The Viewer Display module [423] receives the session's visual and audio data (audio path not shown) from the communications Network [424] and reconstructs the visual appearance of the required shots by decoding the image information and displaying it in the appropriate layers via the Viewer Interface module [423].

### DETAILED DESCRIPTION OF AN EXEMPLARY EMBODIMENT

An exemplary embodiment of the present invention as described herein builds upon prior art for capturing and processing audio and visual data. Specifically, it utilizes the WebLeamer product and the InterPointer device described above to provide audio input and to analyze and produce visual information about a portion of the whiteboard, which is typically used with the present invention. It also uses various information encoding techniques from prior-art, such that the stream of information representing each component of the visual scene is encoded in a manner appropriate to its nature and its rate of change. For example, the video image of the instructor is encoded using a video codec, such as MPEG-4, while projected slides are encoded individually as distinct compressed images using one of several graphic formats common in the industry.

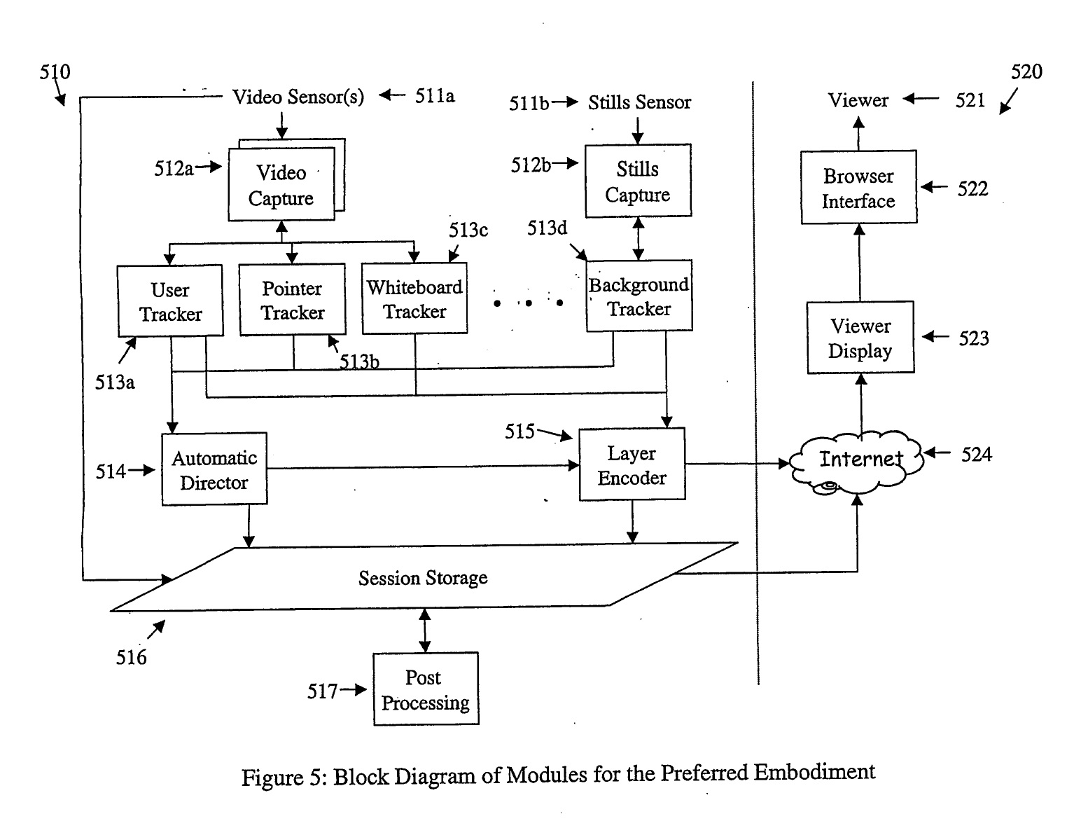

The exemplary embodiment may be well suited to record sessions in rooms that are similar to what is shown in FIG. 1. FIG. 5 shows a block diagram of the central modules for the preferred embodiment. In FIG. 5 the generic modules of FIG. 4 have been replaced with modules that are specific to this embodiment. Several modules of WebLeamer, for example those that control capture from a document camera and the projected touch panel, have been omitted for the sake of brevity. The recording site [510] has one or more Video Sensors [511a] that are trained at portions of the visual scene [11]. For example, one digital camcorder may capture the entire scene and another video camera may capture only the area of projected slides [13] as WebLearner does today. Another Stills Sensor [511b] is trained on the entire visual scene [11]. This is a high-resolution digital camera that captures background images periodically and upon demand. As stated above, additional cameras, such as a document “visualizer” camera may also be incorporated into the system. The Video Capture modules [512a,b] acquire the images and pass them to appropriate tracking modules. Note that video images may also be retained in video storage (such as a camcorder's tape cassette) for retrieval during post-session processing—hence the connection shown to the Session Storage [516].

Each of the tracking modules [513a-d] tracks activity for a different layer of the visual scene. The Whiteboard Tracker [513c] and Pointer Tracker [513b] detect markings/erasures on the whiteboard or other writing surfaces and pointing by a pointing device respectively. They are based on the capabilities of WebLearner and InterPointer, however they are not restricted to the projected area of a whiteboard [13]. Common detection techniques adopted from these and other prior art make it possible to accurately defect the location and appearance of markings (and erasure) made on the writing surfaces [12] in the entire visual scene [11] as well as the activation of a pointing device such as the InterPointer anywhere in the scene. These trackers provide the visual input required for such layers as [37] and [38] and a “pointer” layer not depicted in FIG. 3.

The User Tracker [513a] detects the instructor [15] in the sequence of video frames and is capable of defining an accurate outline of the instructor in any of the given video images. Given a stable, unchanging background this can be accomplished with techniques that are common in the art, such as background subtraction, motion analysis and optical flow. In addition, it can determine whether the instructor appears to be pointing (e.g. at the poster [14]) and will usually supply an accurate determination of the direction at which the instructor is looking—based on an analysis of the orientation of the instructor's face. These capabilities utilize shape and feature recognition techniques also common in the art. The User Tracker provides visual information about the instructor layer [35] as well as the “pointer” layer.

The Background Tracker [513d] provides high-resolution images of the entire visual scene [11] and any temporally stable portions thereof Periodic captures allow updating the current background layer [31] as well as providing updated high quality visual data for any other layer—for example, to display previously written markings with higher quality. Additional Element Tracker [413] modules may be implemented to provide specific tracking for other visual elements such as physical objects [16], posters, charts and maps [14] and more. This is warranted when specific activities exist that are related to these elements or when specialized image processing is required.

The various tracking modules supply image data and information about the activity related to the different visual elements to both the Automatic Director [514] and the Layer Encoder [515]. In order to properly interpret the image data arriving from multiple capture sources these modules must be able to perform a geometric matching, or warping transformation that eliminates the differences in perspective between the sensors and optical distortions that each sensor may have. All visual input is transformed by a warping process to a common coordinate system for the entire visual scene. The computation of the warping transformations is accomplished before the session starts by a calibration process such as that described in the aforementioned prior art.

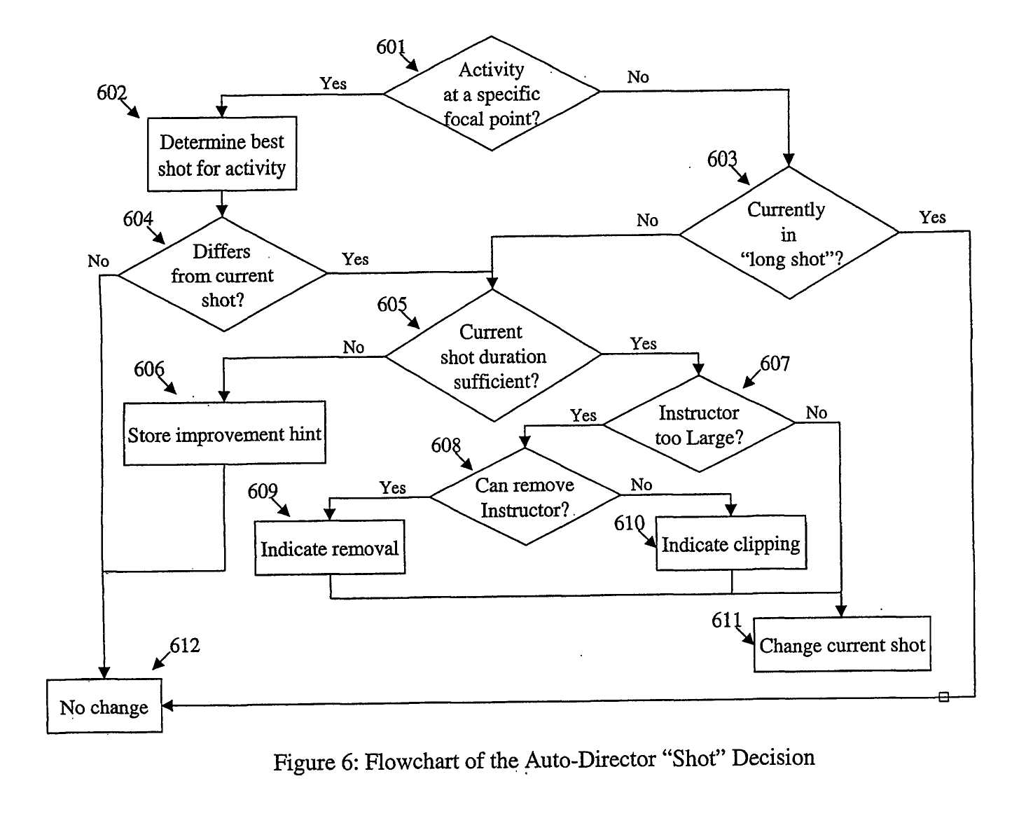

In addition to the visual information it receives, the Automatic Director [514] may be notified of events that are generated by other software modules operating on the computer. For example, if slide-presentation software is controlling the display of slides, a Projection Tracker (not shown) can notify the Automatic Director when the currently projected slide is changed (advanced). Based on the input it receives, the Automatic Director [514] determines whether there is currently a specific focal point of activity, and—based on this determination—it decides how best to frame the preferred current shot and how it should be displayed to the viewer. In general, the Automatic Director may distinguish between a “long shot” of the entire visual scene [11], “medium” shots showing a subset of the scene that contains a large portion of it, and “close-up” shots that contain only a small region, such as the projected area [13] or poster [14]. Once a particular shot is chosen it will remain the active preferred shot for at least a minimum duration of time (for example, several seconds) to avoid creating an unpleasant viewing effect of extremely rapid jumps. Once this minimum interval has passed, the next transition may take place if the focal point of activity appears to be changing. It can be performed either during a single cycle or as a gradual transition over several cycles. By using a gradual transition the Automatic Director [514] can create a “panning” effect to simulate a slow turning of the camera so as to smoothly follow the motion of the instructor. This module also decides which layers should be displayed in the shot (e.g. with or without the instructor) and the precise definition of the source and target display areas, i.e., the rectangular area in the visual scene to transmit and the rectangular area that this information should occupy on the viewer's display. FIG. 6 provides a simplified flow-chart of the logic that the Automatic Director may use in its analysis to decide on the current shot.

First, based on its inputs the Automatic Director determines if there is activity in any specific focal point being tracked by the tracker modules [601]. If there is, it determines the shot that optimally contains this activity [602]. This is determined as follows. The Automatic Director first checks if at least one of the visual element tracking modules [513a-d] has reported activity related to its visual element, such as written markings or pointing, or if external software has reported a recent event, such as slide navigation. For each reported activity or event the Automatic Director is provided with geometric information defining the region of assumed activity. Probability information may be added to indicate the degree of certainty associated with the reported activity. When there are multiple, conflicting activities the Automatic Director can use a heuristic algorithm based on the available information and based on a predefined prioritization of activities to determine the optimal shot. When such a decision cannot be made with a high degree of certainty, the Automatic Director may avoid close-up shots and give preference to longer shots, i.e. it may choose a view that safely includes current activities without “zooming in” on a potentially inactive region. Once the optimal shot is chosen, we proceed to check if this shot differs from the current shot decided in the previous operation cycle [604]. If not, there is no need to change shots and the cycle completes [612]. If the new shot differs from the current one, consideration is given to changing the current shot by testing the duration of the current shot [605]. Similarly, if no specific activity was detected [601] and the current shot is not a “long shot,” i.e. it frames a specific focal-point, consideration is given to changing to a “long shot” and proceed to [605]. If the current shot has not been active for a predefined minimum duration, e.g. 3 seconds, it may be unnatural to switch so soon to a different shot. Therefore, a “hint” for post-session improvement [606] may be stored, indicating that the Post-Processing module [517] should reconsider whether the current shot should be retroactively replaced with the new preferred shot. However, in real-time operation the shots may not change if the current shot has not been active for the predefined minimum duration and the cycle completes [612]. A possible exception to this rule occurs if the new shot can be reached by a small amount of “panning,” i.e. by shifting the rectangle of the source area, in which case the Auto Director can decide to initiate a limited panning operation before the fill minimum duration has been reached. Otherwise, if the current shot has been active long enough, a change to the new shot will occur. However, first a determination may be made as to whether all layers should be visible in the new shot. For example, the Automatic Director decides whether the instructor should be visible to the remote viewer. This decision can be based on various considerations—whether the instructor is blocking fine detail that ought to be left visible (e.g. text on the poster, slide contents or annotations etc.), whether the instructor's current gestures may be of interest to the viewer, how large the instructor appears in the shot, and other considerations. In FIG. 6 a simplified decision based only on the instructor's size is shown. This consideration is based on an assumption that when the image of the instructor is very large in the given shot, too much communication bandwidth maybe required in order to transmit the instructor's image with good quality and it is also possible that the instructor is blocking other, useful information. Hence in [607] a check is made to determine if the instructor's relative area in the shot exceeds a predefined limit. If it does, either the instructor is removed from the layered result [609] or the instructor's image [610] is “clipped”. The distinction between these possibilities is made based on heuristics as to whether the instructor's presence in the viewed image is informational for this shot or not [608]. In any of these cases the current shot is ultimately changed to the newly determined one [611]. It should be noted that an alternative to removing or clipping the instructor's image [609], [610] is to dynamically produce scaling parameters for the region of the images containing the instructor. When the instructor's size grows in the video, image bandwidth can be conserved (with some loss of quality) by scaling down the region containing the instructor. The converse holds as well. In either case this does not affect the resulting viewing experience other than in aspects of video quality.

The Layer Encoder module [515] generates and efficiently encodes a layered composite view of the visual scene that changes throughout the duration of the session. The first layer is the background of the visual scene [31] and consists of a static (unchanging), high-resolution image, which can be acquired from a stills camera. This image can be encoded in JPEG format, for example, and transmitted once—either in full quality for advance transmission when the session begins playback or by gradually improving it over time using standard progressive encoding techniques. The next image layer consists of the projected slides or other computer-generated images [33], which are obtained either from the software application responsible for projecting them (as in WebLearner) or from a high-resolution camera source. These images are also encoded using standard graphic formats. The next layer contains markings on writing surfaces such as the whiteboard or flipchart [37] [38], which can utilize standard raster or vector representation formats. The next layer displays a “cursor” to indicate pointing with the InterPointer, other pointing device or the instructor's finger. This is encoded simply as a time-stamped coordinate pair. The next layer contains the moving image of the instructor [35]. This may be encoded using a standard video codec. Finally, any object manipulated by the instructor may occupy yet another layer [36]. Additional layers are conceivable depending on the configuration of the recording site.

The changes to each layer are encoded in an efficient manner using well known encoding techniques for still and video images, while omitting information that does not change from one processing cycle to the next. The encoding algorithm differs for each layer and is adapted to the particular attributes of that layer. For example, the fine details of markings are best encoded using lossless compression methods as opposed to lossy compression techniques typically used for background images or motion video. In addition, each layer requires updates at a varying rate. The background may be essentially static and may never require updating. Slides, annotations, and other elements may change infrequently and thus require periodic updates of localized regions. On the other hand, the instructor's appearance and location may change rapidly and require frequent updates. Thus, the segmentation into distinct layers, each of which has a different characteristic rate of change and where each layer can be optimally encoded using an algorithm that best suites its visual properties and its contribution to the informational content of the session provides a significant advantage in data compression, which results in efficient use of bandwidth-limited communication channels. It is possible to use tools based on standards such as MPEG-4 to encode several of the described layers inside a single encoding framework while maintaining bandwidth efficiency. Specifically, some video encoding frameworks support the encoding of arbitrary shaped objects and can be used to efficiently transmit components of the visual scene described herein. Alternatively, ordinary video codecs that handle rectangular video may be used to encode the instructor image. In this case, high quality can be maintained by encoding a modified video image in which the background (non-instructor) regions have been transformed so as to minimize the bandwidth required to represent them. Techniques that may be used in this regard include, for example, low-pass filtering background regions to remove edges and overlaying the most recent instructor region on top of the previously encoded image without modifying the background—thus minimizing the amount of change between successive encoded frames. Any useful transformation maybe performed on these regions to minimize their impact on communication bandwidth because they are ignored when decoding the data stream and reconstructing the visual experience.

The resulting information is both stored in Session Storage [516] and transmitted to the Internet (or other network) [524]. The Post-Processing module [517] operates after the session completes by accessing all the stored data and revising the decisions and layered image results of the real-time session to produce an improved result. In addition, a module for manual editing of the session may be used to allow a human operator to further improve the session by overriding automatic decisions, removing unwanted segments, adding other resources etc.

At a remote viewer's site [520] the Viewer (human) [521] may use a standard “internet browser” software interface [522] to view the session. The Viewer Display module [523] decodes the data that was transmitted from the recording site, reproduces the composite layered view that corresponds to what the Layer Encoder [515] maintained during the recording, and displays the result via the Browser Interface [522]. At the remote viewer' site, for both synchronous and asynchronous modes, the Viewer can turn off the Automatic Director and decide to zoom-in, zoom-out or shift the view of the Viewer Display to other parts of the scene, if provided. Visual information for parts of the scene that lie outside the current preferred shot is provided to remote viewers to the extent that communication bandwidth is available.

The techniques described herein are not limited to any particular hardware or software configuration; they may find applicability in any computing or processing environment. Additionally, the techniques set forth above may be implemented using hardware, software or a combination of both. As will be understood by one of ordinary skill in the art, that while the exemplary embodiments described herein characterize the present invention as being utilized over the Internet, access could also be provided by over any type of public access network or private access network. Moreover, while the present invention has been particularly shown and described with respect to an exemplary embodiment, it will be understood by one of ordinary skill in the art that the foregoing and other changes in form and details may be made therein without departing from the spirit and scope of the present invention.

What is claimed is:

1. A method of providing audio-visual data to convey a dynamic session at a site to remote viewers, said method comprising:
capturing said data from said site;
analyzing said data;
segmenting said data into distinct components differing from each other by at least one characteristic;
selectively encoding said data components;
transmitting said encoded data components;
decoding and reconstructing said data; and
displaying said data to said remote viewers.
